(19) United States
(12) Patent Application Publication
(10) Pub. No.: US 2010/0179865 A1
(43) Pub. Date: Jul. 15, 2010

(54) MULTIMEDIA CONTENT CACHE

(75) Inventors: Patrik N. Lundqvist, Encinitas, CA (US); Guilherme K. Hoefel, La Jolla, CA (US); Robert S. Daley, Del Mar, CA (US); Jack B. Steenstra, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/351,535

(22) Filed: Jan. 9, 2009

(51) Int. Cl. G06Q 30/00; G06F 12/08; G06N 5/02; G06F 12/12; G06F 17/00; G06F 15/16

(52) U.S. Cl. 705/14.4; 711/126; 706/46; 711/129; 711/133; 700/94; 709/219; 711/E12.017; 711/E12.022; 711/E12.041; 711/E12.069

(57) ABSTRACT

Music can be broadcast from a radio station and recorded onto a cache of a personal electronic device, such as a portable digital music player. The recording can occur such that there is segmenting of music into different cache portions based upon classification. Instead of playing music from the radio station, music can be played from the cache to ensure high quality and desirable variety. Different rules can be used to govern which music is played as well as how music should be removed from the cache. In addition, targeted advertisements can be used that relate to the music in the cache as well as a user location.

### BACKGROUND

1. Field

The following description relates generally to wireless communications and, more particularly, to managing multiple multimedia services, commonly in conjunction with a mobile device.

2. Background

Wireless communication systems are widely deployed to provide various types of communication content such as, for example, voice, data, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

MIMO systems commonly employ multiple (NT) transmit antennas and multiple (NR) receive antennas for data transmission. A MIMO channel formed by the NT transmit and NR receive antennas can be decomposed into NS independent channels, which can be referred to as spatial channels. Each of the NS independent channels corresponds to a dimension. Moreover, MIMO systems can provide improved performance (e.g., increased spectral efficiency, higher throughput and/or greater reliability) if the additional dimensionalities created by the multiple transmit and received antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region. FDD and TDD can be implemented upon a MIMO system through a WWAN (Wireless Wide Area Network). However, conventional techniques can provide limited or no feedback related to channel information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one aspect, there can be a method for managing cache storage. The method can include identifying multimedia content as well as retaining at least a portion of the identified multimedia content automatically in a cache in a format used by the cache.

In another aspect, there can be an apparatus that includes a recognizer that identifies multimedia content. Moreover, the apparatus can include a maintainer retainer at least a portion of the identified multimedia content automatically in a cache in a format used by the cache.

In a further aspect, there can be at least one processor configured to manage cache storage. The processor can include a first module for identifying multimedia content. The processor can also include a second module for retaining at least a portion of the identified multimedia content automatically in a cache in a format used by the cache.

In yet another aspect, there can be a computer program product. The computer program product can include a computer-readable medium with a first set of codes for causing a computer to identify multimedia content. Moreover, the product can include a second set of codes for causing the computer to retain at least a portion of the identified multimedia content automatically in a cache in a format used by the cache.

With an additional aspect, there can be an apparatus that uses means for identifying multimedia content. The apparatus can also include means for retaining at least a portion of the identified multimedia content automatically in a cache in a format used by the cache.

With an aspect disclosed herein, there can be a method for providing multimedia content. The method can include identifying a broadcast load as well as determining an amount of multimedia content to provide based upon the identified load.

With a further aspect, there can be at least one processor configured to provide multimedia content. The processor can include a first module for identifying a broadcast load. Moreover, the processor can include a second module for determining an amount of multimedia content to provide based upon the identified load.

With an additional aspect, there can be a computer program product with a computer-readable medium. The computer-readable medium can include a first set of codes for causing a computer to identifying a broadcast load. Additionally, the computer-readable medium can include a second set of codes for causing the computer to determine an amount of multimedia content to provide based upon the identified load.

With another aspect, there can be an apparatus with means for identifying a broadcast load as well as means for determining an amount of multimedia content to provide based upon the identified load.

In yet another aspect, there can be an apparatus with a classifier that identifies a broadcast load. Additionally, the classifier can include a resolver that determines an amount of multimedia content to provide based upon the identified load.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a representative multimedia device in accordance with regard to an aspect disclosed herein.

FIG. 3 is an illustration of a representative system for information distribution and placement of the distributed information into a cache in accordance with regard to an aspect disclosed herein.

FIG. 4 is an illustration of a representative content classification system in accordance with regard to an aspect disclosed herein.

FIG. 5 is an illustration of a representative system for managing content concerning content usage in accordance with regard to an aspect disclosed herein.

FIG. 6 is an illustration of a representative system for managing content concerning temporal characteristics in accordance regard to with an aspect disclosed herein.

FIG. 7 is an illustration of a representative system for managing content concerning quality level with regard to an aspect disclosed herein.

FIG. 8 is an illustration of a representative system for managing content concerning content expiration in accordance with regard to an aspect disclosed herein.

FIG. 9 is an illustration of a representative system for usage of retained content in accordance with regard to an aspect disclosed herein.

FIG. 10 is an illustration of a representative system for managing content disclosure in accordance with regard to an aspect disclosed herein.

FIG. 11 is an illustration of a representative content classification methodology in accordance with regard to an aspect disclosed herein.

FIG. 12 is an illustration of a representative content management methodology in accordance with regard to an aspect disclosed herein.

FIG. 13 is an illustration of a representative methodology for multimedia content distribution in accordance with regard to an aspect disclosed herein.

FIG. 14 is an illustration of a representative methodology for engaging with a mobile store in accordance with regard to an aspect disclosed herein.

FIG. 15 is an illustration of a representative methodology for radio service management in accordance with regard to an aspect disclosed herein.

FIG. 16 is an illustration of an example mobile device that facilitates placement of multimedia content upon a cache in accordance with regard to an aspect disclosed herein.

FIG. 17 is an illustration of an example system that facilitates relay of multimedia content in accordance with regard to an aspect disclosed herein.

FIG. 18 is an illustration of an example wireless network environment that can be employed in conjunction with the various systems and methods described herein.

FIG. 19 is an illustration of an example system that manages storage of information upon a cache in accordance with regard to an aspect disclosed herein.

FIG. 20 is an illustration of an example system that distributes multimedia content in accordance with regard to an aspect disclosed herein.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more embodiments.

As used in this application, the terms “component,” “module,” “system” and the like are intended to include a computer-related entity, such as but not limited to hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, portable (or personal) media player (PMP), or other processing devices connected to a wireless modem. Moreover, various aspects are described herein in connection with a base station. A base station can be utilized for communicating with wireless terminal(s) and can also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques. Additionally, aspects can be practiced in relation to MediaFLO, DVB-H (Digital Video Broadcasting-Handheld), ISDB-T (Integrated Services Digital Broadcasting-Terrestrial), and the like.

Various aspects or features will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

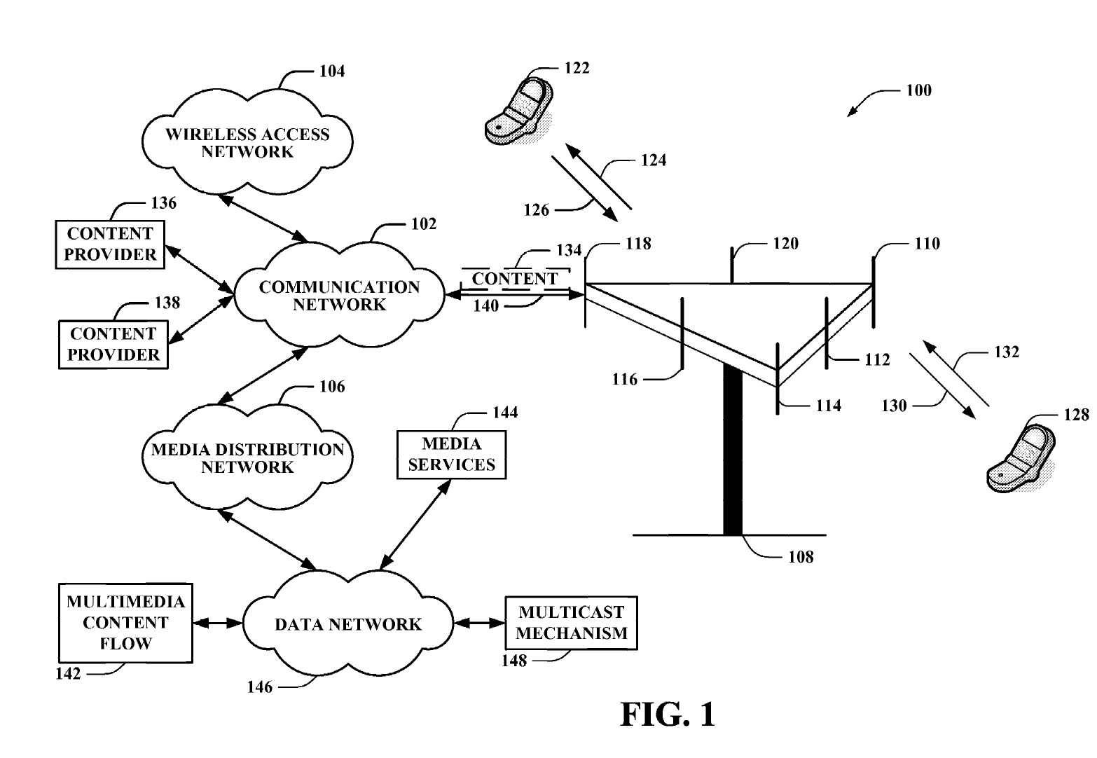

Referring now to FIG. 1, a wireless communication system 100 is illustrated in accordance with various embodiments presented herein. In some aspects, a communication network 102 comprises a wireless access network 104 operable to enable wireless communications and a media distribution network 106 operable to distribute a plurality of content 134 to a plurality of wireless devices, including wireless devices 122 and 128. System 100 comprises a base station 108 that can include multiple antenna groups. For example, one antenna group can include antennas 110 and 112, another group can comprise antennas 114 and 116, and an additional group can include antennas 118 and 120. Two antennas are illustrated for each antenna group; however, more or fewer antennas can be utilized for each group. Base station 108 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 108 can communicate with one or more mobile devices such as mobile device 122 and mobile device 128; however, it is to be appreciated that base station 108 can communicate with substantially any number of mobile devices similar to mobile devices 122 and 128. Mobile devices 122 and 128 can be, for example, cellular phones, smart phones, laptops, handheld communication devices, handheld computing devices, satellite radios, global positioning systems, PDAs, and/or any other suitable device for communicating over wireless communication system 100. As depicted, mobile device 122 is in communication with antennas 118 and 120, where antennas 118 and 120 transmit information to mobile device 122 over a forward link 124 and receive information from mobile device 122 over a reverse link 126. Moreover, mobile device 128 is in communication with antennas 110 and 112, where antennas 110 and 112 transmit information to mobile device 128 over a forward link 130 and receive information from mobile device 128 over a reverse link 132. In a frequency division duplex (FDD) system, forward link 124 can utilize a different frequency band than that used by reverse link 126, and forward link 130 can employ a different frequency band than that employed by reverse link 132, for example. Further, in a time division duplex (TDD) system, forward link 124 and reverse link 126 can utilize a common frequency band and forward link 130 and reverse link 132 can utilize a common frequency band.

The set of antennas and/or the area in which they are designated to communicate can be referred to as a sector of base station 108. For example, multiple antennas can be designed to communicate to mobile devices in a sector of the areas covered by base station 108. In communication over forward links 124 and 130, the transmitting antennas of base station 108 can utilize beamforming to improve signal-to-noise ratio of forward links 124 and 130 for mobile devices 122 and 128. Also, while base station 108 utilizes beamforming to transmit to mobile devices 122 and 128 scattered randomly through an associated coverage, mobile devices in neighboring cells can be subject to less interference as compared to a base station transmitting through a single antenna to all its mobile devices.

Further, communication network 102 comprises one or more content providers 136, 138 operable to provide all or some portion of the plurality of content 134 for distribution to users in network 102. For example, the plurality of content 134 supplied by content providers 136, 138 may comprise at least one of video, audio, multimedia content, real-time content, non real-time content also referred to as “clips,” scripts, programs, data or any other type of suitable content. The plurality of content 24 may include one or any combination of subscribed to programming, ad hoc and/or on-demand programming, advertising or any other form of content presented during a break within and/or simultaneously with other content. In some aspects, content providers 136,138 communicate with the media distribution system 106 via a communication link 140, which may comprise any suitable type of wired and/or wireless communication interface.

In some aspects, media distribution network 106 may comprise a transport system that operates to create and transport a multimedia content flow 142, including one or more media services 144, across one or more data network 146. For example, such a transport system may include a multicast mechanism 148. In some aspects of multicasting, each flow 142 is a logical stream within a “multiplex,” which is a set of flows available in a given geographical area. For example, multicast mechanism 148 may comprise all or some portion of a multicast system such as a Forward Link Only (FLO) network, including the MEDIAFLO™ System available from Qualcomm, Inc. of San Diego, Calif. It is to be appreciated that MediaFLO is one example of a broadcast network, and that other examples may include DVB-H (Digital Video Broadcasting-Handheld) and T-DMB (Terrestrial-Digital Multimedia Broadcasting) systems. Further, media service 144 comprises one or some combination of the plurality of content 134, where a media service customized for a specific retailer may be referred to as a “channel.” As such, each flow 142 is able to deliver the same service 144 to a plurality of endpoints at the same time, as the flow is available to any device tuning in to the proper frequency, thereby avoiding scalability issues. Therefore, media distribution network 106 may be operable to transport media content in a one-to-many fashion.

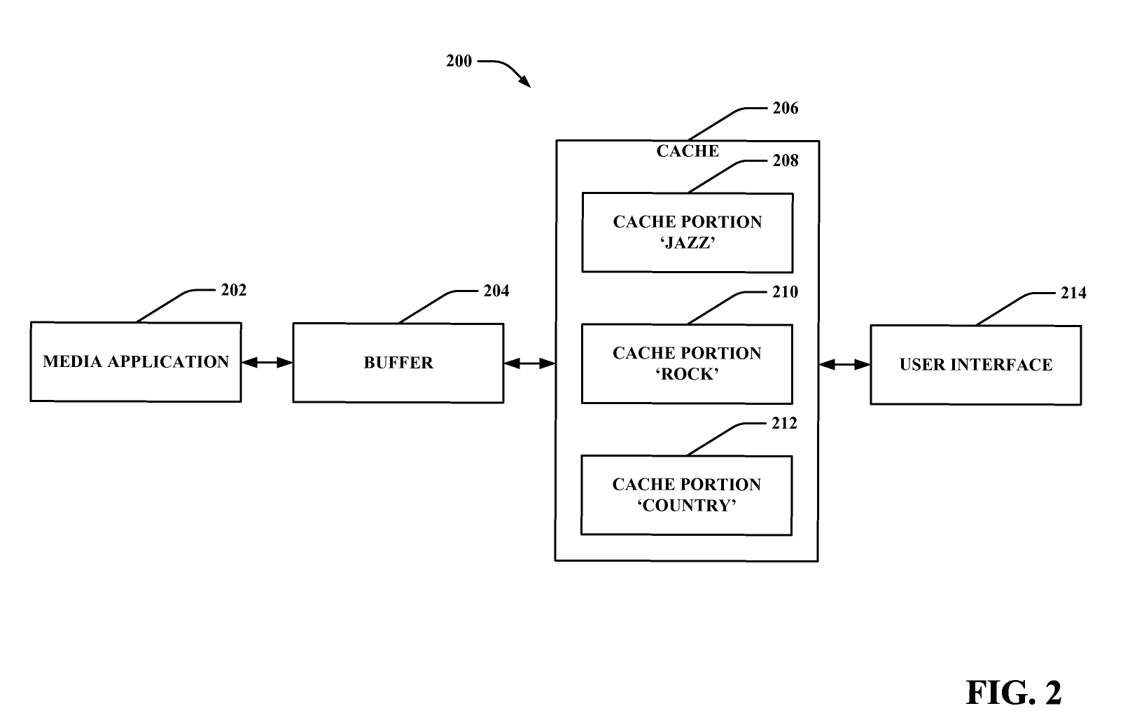

Now referring to FIG. 2, an example system 200 is disclosed for managing retention of information (e.g., multimedia content such as music, videos, Internet broadcasts, etc.). A media application 202 can be used to stream content from a source to a content device (e.g., the mobile device 122 or 128 of FIG. 1). The media application 202 can function such that multiple streams of information can be transmitted to the content device at a single time.

A buffer 204 can be used as a temporary storage location for streamed information collected by the media application 202. Various modules can operate upon the information retained in the buffer 204. For instance, there can be analysis of the information to determine characteristics, perform a classification, etc. In addition, the buffer 204 can be used to temporarily retain information until a determination can be made on other portions of the system 200 (e.g., determine if there is room in a cache 206 for the information to be stored).

A cache 206 can be used to retain information obtained through use of the media application 202. According to one embodiment, the cache 206 can operate as a sectored cache such that the cache 206 is divided (e.g., physically, logically, etc.) into different portions. For example, the media application 202 can obtain streamed music from a radio station. The buffer 204 can temporarily retain the music while a classification of the music is determined (e.g., jazz, pop, etc.). Based upon the classification, different cache portions can be used for retention of information types (e.g., a grouping of songs in a particular genre). For instance, there can be a cache portion 208 for jazz music, a cache portion 210 for rock music, and a cache portion 212 for country music. It is to be appreciated that one song can be retained in multiple cache portions (e.g., a song that includes rock music and country music elements can be retained in portions 210 and 212). In one implementation, a song is physically retained in one portion but logically retained in multiple portions (e.g., can be accessed

The size of the cache portions 208, 210, and 212 can be designated by a user as well as adaptively changed automatically based upon how often the user listens to a particular music type (e.g., ongoing modification based upon user habits). In addition, a user can request that a new cache portion be created and/or a cache portion be removed. For instance, the user can request the cache portion 210 for rock music be divided into two new portions—one portion for hard rock and one portion for soft rock. The cache 206 can automatically be modified such that the change is implemented. While being disclosed as user initiated, it is to be appreciated that the cache 206 can self-modify, the cache 206 can be modified through use of a third-party entity, etc. In addition, the cache 206 and/or cache portions can operate on a first-in-first-out basis.

A user interface 214 can operate in conjunction with an overall user experience so music is played from the cache 206. The user experience can allow a user to select a channel that corresponds to a cache portion and thus allow different functionality (e.g., stop, repeat, skip, etc.). The user interface 214 can disguise playing from the cache 206 as originating from a radio station. According to one implementation, live, streaming content is saved to the cache 206 and the content being output from a device implementing the system 200 “lags” the received streaming content. This “lag” allows the device to maintain quality, etc., such as based on temporarily losing signal there would not be an impact upon a user's perception of the live stream.

With one embodiment, a user can listen exclusively to content on the cache 206 and could be unaware that she is not listening to live content. For instance, the media application 202 can present to the user a large number of virtual radio stations (e.g., through the user interface 214). The device could capture the songs from a live music broadcast service or from a tailored and dedicated broadcast service for this embodiment. A particular song can be assigned to specific radio stations based on meta-data associated with the song (e.g., based on genre) and played for the user while the user designates an appropriate station. The device could continue to capture new content being broadcasted to supply and maintain the cache 206 with fresh content to minimize exposure of the user to the same song too many times, e.g., a song to which the user has had multiple exposure can be replaced with a new song being broadcasted. The replacement policy can consider many variables when trying to minimize excessive exposure to the same song, e.g., battery life, battery status, number of songs assigned to each station, current exposure status of songs, users listening habits, etc. A media application radio station can attempt to mirror a live radio station—however, suitable modifications can be made. Advertisements can be integrated with the media application radio station under similar constraints of songs—for instance, that advertisements are related to a genre (e.g., a country music concert advertisement is likely more relevant on a country music station than an advertisement for a new jazz album) and a user is not highly exposed to the advertisement. If connectivity is lost with the broadcast service, then the media application 202 can continue operation without the user becoming aware of the loss. The system 200 can be implemented such that there is no mirror of a live station and the media application 202 presents functional stations to a user through use of the cache 206. This can facilitate that the number of virtual radio stations can be much larger than the number of radio stations a live broadcast service with the same bandwidth could support.

While commonly there is use of broadcasts (e.g., concerning MediaFLO™), it is to be appreciated that aspects disclosed herein can be practiced through a unicast and/or multicast experience on a broadcast network. With unicast, there can be sending of information packets to a single destination. While such transmissions can be picked up by multiple receivers, commonly only an addressed receiver will digest the data. Physically, messages can be directed over those links (e.g., only over those links) in a network (e.g., a network required to achieve delivery)—thereby limiting the number of devices on the network that actually receive the messages to a minimum. Unicast allows a user to request personalized data on the fly—at a time designated by a user, the user can select content which is then transmitted to him.

Regarding multicast, there can be transmitting information packets addressed to a range of receivers. Multicast can typically implement on an otherwise unicast based network using network addressing methods for the delivery of information to a group of destinations simultaneously. Multicast methods generally strive for efficiency through delivering the messages over each link of the network only once, creating copies only when the links to the multiple destinations split (e.g., typically at network switches and routers). Multicast can be used for streaming media and Internet television applications where the media is streamed to all requesting users in the same time frame (e.g., a user is watching the same stream at the same time as the other requesters).

For a broadcast, there can be transmitting information (e.g., packetized, non-packetized) to units capable of receiving the transmission (e.g., all units without distinction). Broadcast network are usually physically separate from unicast based networks as generally, broadcast transmissions of user data is not efficient on a unicast based network. Broadcast networks are also generally thought of as being one way communication paths. For example, the MediaFLO™ system can be described as “forward link only” referring to the one-way flow of data. It is to be noted that most digital video broadcasting networks, such as MediaFLO™, use digital rights management systems to prevent the decoding of the received data absent subscriptions. In some ways this mimics functionality of multicast systems in that only those users electing (e.g., paying) to receive the content can view the content.

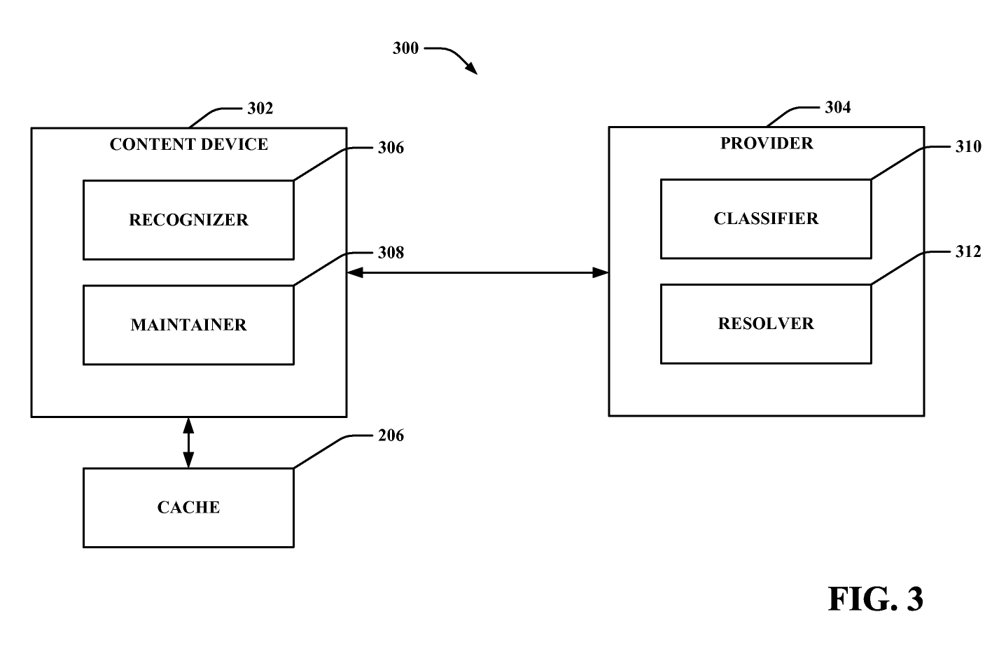

Referring to FIG. 3, an example system 300 is disclosed for using a cache 206 to manage information, such as multimedia content. A content device 302 (e.g., a mobile device 122 or 128 of FIG. 1, cellular telephone, personal digital assistant, music player, etc.) can interact with a provider 304 to collect content. In a conventional configuration, a user can employ a radio to listen to music where the music is broadcast over public airwaves. In addition, a user can download music from a music store and retain the music upon a personal device.

In accordance with aspects disclosed herein, there can be a merger of aspects related to radio play and/or music store with local media usage (e.g., songs stored on a local cache). With one embodiment, a user can attempt to play music from the radio station—however, as opposed to playing music from the radio station (e.g., directly broadcast from the radio station), music can be played from the cache 206. The cache 206 can automatically select a song—selection of a song can be based upon if the song is new or already played, time last played, users explicit feedback for the same song, relation to songs played by a same artist, user implicit feedback (e.g. skipping a song or playing it again), quality, randomization so play does not seem as a endless loop, etc.

Playing music from the cache 206 can enable greater user functionality (e.g., pause music, repeat, etc.), protect from losses in signal coverage from the radio, and the like. In one example, music played from the cache 206 mirrors what is played by the radio; when a signal to the radio is lost, the music continues to play (e.g., notifying the user of the interruption, not notifying the user, and the like). If a song is playing on the live stream that is in the cache, when the live stream is lost the song can be identified in the cache and the song continued. Allowing a user to listen to music from the live source can enable the user to appreciate potential new content and determine if music should be retained. As a song plays from the live stream, it can be retained in the buffer 204 of FIG. 2 (as well as after play for a time) so a user can determine if the content should be retained in the cache 206.

The content device 302 can retain information upon the cache 206 supplied from the cache 206. While the cache 206 is disclosed as being separate from the content device 302 (e.g., as a removable flash memory device), it is to be appreciated that the cache 206 can integrate as part of the content device 302. The content device 302 can use a recognizer 306 that identifies multimedia content, such as music. For example, as information enters the content device (e.g., from a radio station, through download from a music store), an identification can occur on the information—identification that information is music, that the content is multimedia information that is authorized for storage, and the like. Identification can occur through analyzing the information as well as metadata associated with the information and making a determination on identity. Other identifications can occur, such as information not being multimedia content, information being unknown, etc. Once identified, a maintainer 308 can retain at least a portion of the identified multimedia content (e.g., content identified as music) automatically in the cache 206 in a format used by the cache 206 (e.g., performing modification of the content from a transmitted form to a retainable form if appropriate).

The provider 304 can supply multimedia content to the content device 302. A classifier 310 can be used that identifies a broadcast load (e.g., an amount of space available to transmit content). Based upon the identification, a resolver 312 can determine an amount of multimedia content to provide based upon the identified load. For example, the provider 304 can produce multiple songs in one transmission or produce more detailed songs of higher quality (e.g., songs subjected to a higher sampling rate). It is to be appreciated that aspects disclosed herein can be practiced through playing content for the cache 206—playing content for the cache 206 cancan enable more content than can fit on a live channel, can have higher likelihood of availability (e.g., no concern for signal quality), have higher guarantee of quality, and the like.

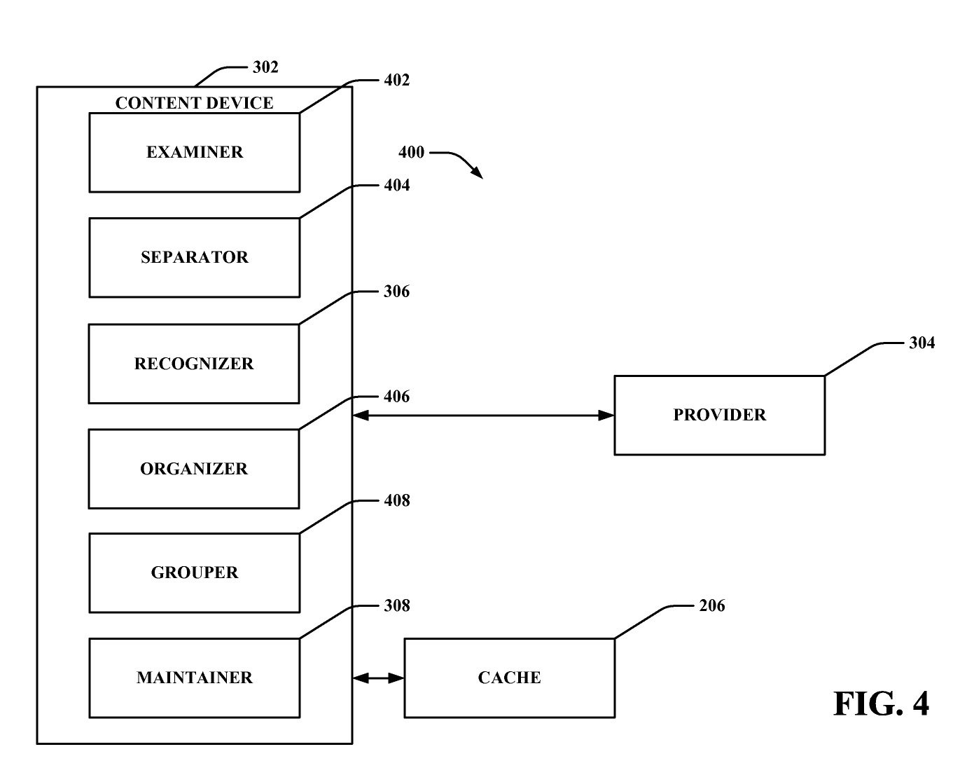

Referring to FIG. 4, an example system 400 is shown for placement of multimedia content upon a cache 206 for use of a content device 302. The placement can be organic such that it follows general desires of a user, commonly based upon past history. An examiner 402 can be employed that observes usage related to multimedia content. Based upon the observation, a separator 404 can determine how to divide the cache 206 (e.g., by classifications, sizes, etc.) and then divide the cache 206 into at least two classifications (e.g., movies, television programs, academic lectures, etc.). In addition, the cache 206 can configure such that a user can override organization of the separator 404 to create new portions, modify size, etc.

A recognizer 306 can be used to identify new content (e.g., transferred from a provider 304) and an organizer 406 can classify the identified multimedia content, such that the classification is based upon the cache portions. According to one embodiment, a collected song can include metadata describing a genre of the song. The organizer 406 can understand the genre through the metadata (e.g., the content is classified by a supplier). In one implementation, the content is placed in a cache portion associated with the genre—if a cache portion does not exist for that genre, then a new portion can be created for the genre. Alternatively, the content can be evaluated and a determination can be made on what existing cache portion the content best fits and/or if the content is close enough to an existing genre to merit placement (e.g., if placement is merited or a determination of portion is made, then storage of the content can occur; if there is not merit, then a new portion can be created and subsequent storage occurs).

A grouper 408 can be used that matches the multimedia content with a classified cache that corresponds to the classification of the multimedia content—this can occur such that there is the automatic retention upon the matched classified cache. It is to be appreciated that content can be placed in more than one cache portion (e.g., in multiple physical locations, in multiple logical locations, etc.). The user can select to override operation of the grouper 408 and manually place content in an appropriate cache portion. A maintainer 308 can automatically retain at least a portion of the identified multimedia content automatically in a cache 206 (e.g., through use of the grouper 408).

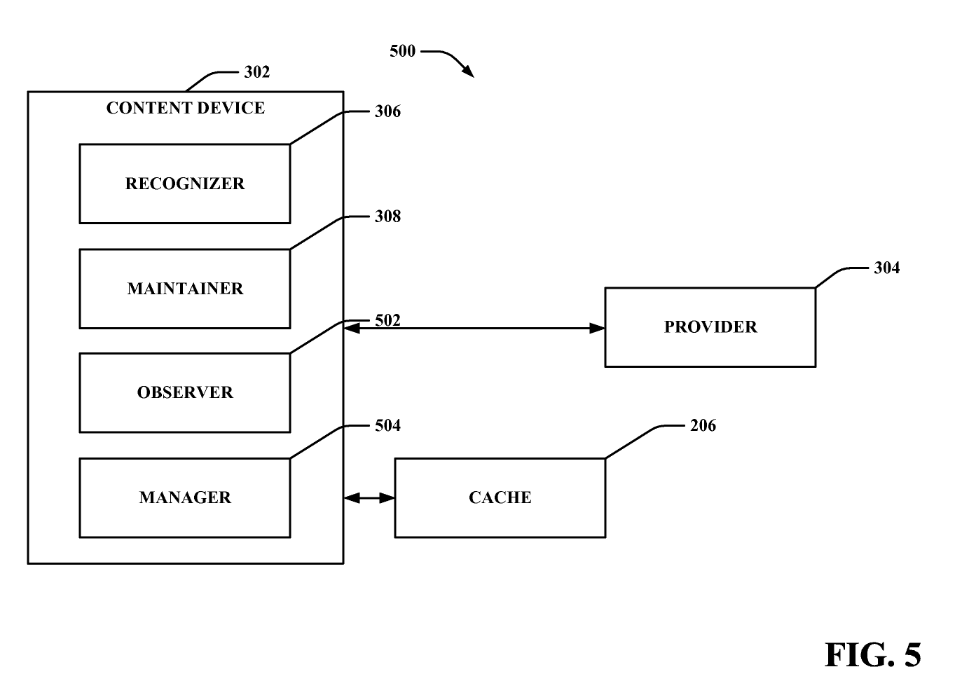

Referring to FIG. 5, an example system 500 for deleting content in a cache 206 of a content device 302 based upon usage of the content is showed. A recognizer 306 can identify multimedia content from a provider 304 and a maintainer 308 can retain at least a portion of the identified multimedia content automatically in a cache 206. With the content placed in the cache 206, a tag can be associated with the content—the tag can signify that the content should be observed for usage.

An observer 502 can be employed that monitors usage of retained multimedia content. In one implementation, each time content is used (e.g., a song is played, a video is watched), a counter can be incremented; however, other implementations can be used, such as random times a check is made and an appropriate counter is incremented. A threshold level can be used, and when the counter is equal to or greater than the level, the content can be deleted. A manager 504 can be used that determines if the retained content should be deleted based at least upon a result of the monitoring—upon a positive determination, the content can be deleted. Limiting content by a number of times the content is played can assist in eliminating how often a piece of content is played. After deletion, there can be a time period determined and used before the content can again be retained in the cache 206. According to one embodiment, the manager 504 does not function without consent of the user (e.g., globally, with each deletion, etc.) or the threshold level is provided by the user.

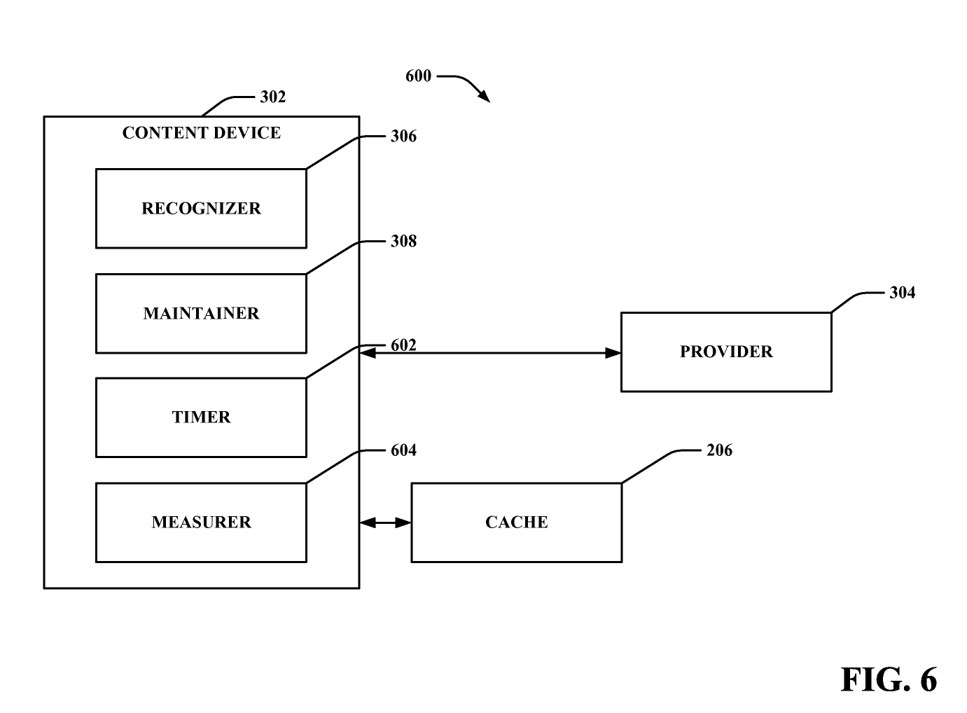

Referring to FIG. 6, an example system 600 is disclosed for deleting content from a provider 306 or other source upon cache 206 based upon the content remaining on the cache 206 for too long of a period of time. A recognizer 306 can identify multimedia content perceived by a content device 304 that should be retained upon the cache 206—the content commonly originates from a provider 306 (e.g., via a base station). A maintainer 308 can determine if the content should be retained and automatically retain the content based upon a positive determination.

When retaining the content, a timestamp can be associated with the content to disclose when the content enters the cache 206. A timer 602 can be used that determines an amount of retention time for retained multimedia content. The amount of retention time used to determine when to delete can be designated by a user, supplied through use of artificial intelligence techniques, etc.

It is to be appreciated that artificial intelligence techniques can be used to practice determinations and inferences disclosed in the subject specification. These techniques employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. These techniques can also include methods for capture of logical relationships such as theorem provers or more heuristic rule-based expert systems. These techniques can be represented as an externally pluggable module, in some cases designed by a disparate (third) party.

A measurer 604 can determine if the retained content should be deleted based at least upon the determined retention time such that content with a longest retention time is deleted. According to one embodiment, when content is retained for a period of time, the content can be deleted (e.g., automatically, with user approval, etc.). However, content automatic deletion can be limited such that content retained for a longest period is deleted when space is at a premium (e.g., to create storage space for new content). Multiple factors can be taken into account when determining if deletion should occur (e.g., period of time, number of times content is played, etc.). The measurer 604 can be limited in functionality such that operation is restricted for times when there is a need for more memory—a determination is made from the measurer 604 that there is a need for more space and the measurer 604 can determine what content should be deleted (e.g., based upon number of times used, time retained on the device, etc.).

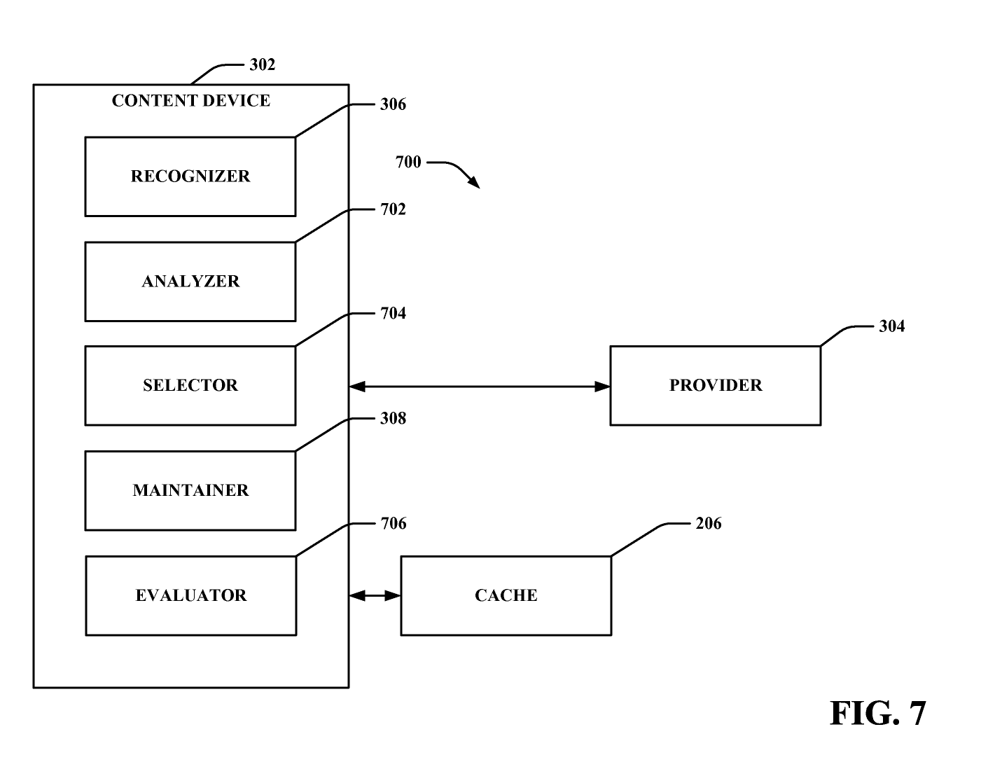

Referring to FIG. 7, an example system 700 is disclosed that regulates retention of information upon a cache 206 for a content device 302—the information can originate from a provider 304. A recognizer 306 can be used that identifies multimedia content. According to one embodiment, a user can download content for a music store and based upon a download request, identification can occur.

Quality of content (e.g., audio quality for a song, quality derived from a wireless connection, etc.) can be of high importance. An analyzer 702 can be used that determines a quality level of the multimedia content. A selector 704 can determine if the multimedia content is of a sufficient quality level, automatic retention occurs upon determining that the identified multimedia content is of the suitable quality level. If a negative determination is made (e.g., the level is not of a high enough quality), then content can be disregarded. For example, obtained content can be compared against matching content (e.g., a same song) and a conclusion can be drawn on which song is of higher quality—a higher quality song is retained while a lower quality song is deleted. A maintainer 308 can retain at least a portion of the identified multimedia content automatically in a cache 206.

Deletion can occur based upon a quality level of content. For example, content can be retained in the cache 206 until the cache 206 is filled. Upon filling the cache 206, content can be deleted based upon content quality (e.g., content with a lowest quality is deleted first). An evaluator 706 can be used that determines if the retained content should be deleted based at least upon the determined quality level of the retained multimedia content such that multimedia content of a lowest quality level is deleted. Other examples of removal from a full cache 206 are longest in time, designated by a user, first in-first out, expiration, etc.

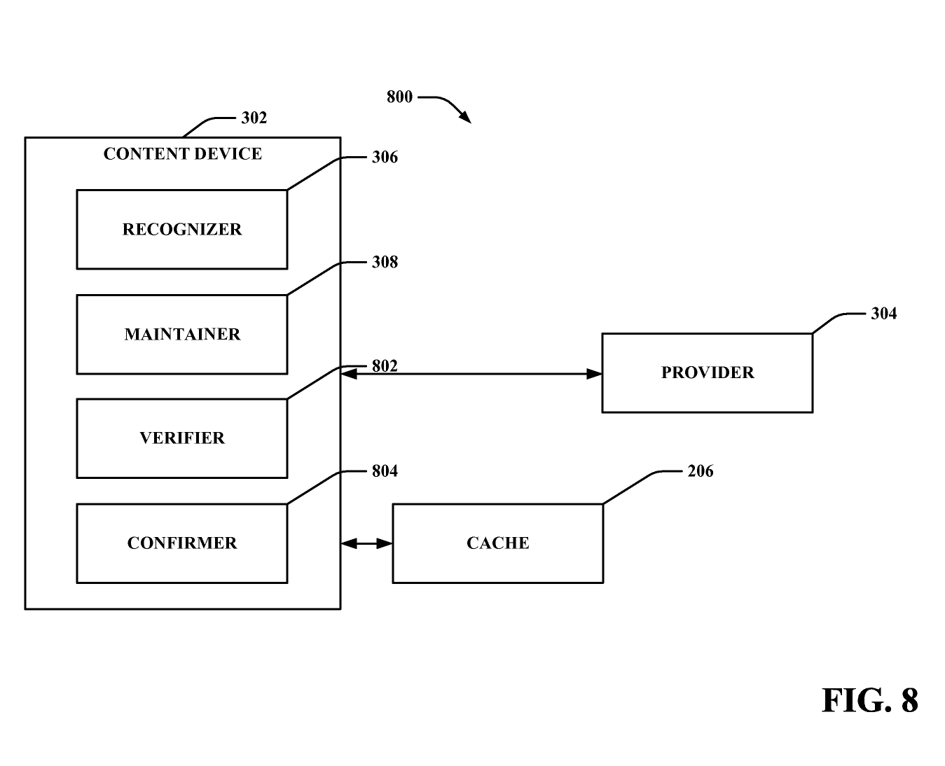

Referring to FIG. 8, an example system 800 is disclosed for regulating content retention regarding content expiration. A provider 304 can transfer multimedia content to a content device 302. According to one embodiment, the provider 304 can sell or give the content to the content device 302—however, there can be restrictions on the content such as the content cannot be saved elsewhere (e.g., a location other than the cache 206), the content is to be deleted after a number of plays, deleted after a set amount of time, etc. An identifier 302 and maintainer 304 can facilitate placement of the content upon the cache 206.

A verifier 802 can determine if retained multimedia content is expired (e.g., been retained too long, played too many times, there is a violation of a usage agreement, there is tampering with the cache 206, etc.). A confirmer 804 can delete the retained multimedia content if it is determined that the content is expired. A notice can be transferred to the user notifying of the deletion. In an alternative embodiment, when expiration occurs, a notice can be given to a user that deletion occurs until the user takes an action (e.g., negotiates to have the expiration removed by paying more money, user requests deletion not occur, and the like).

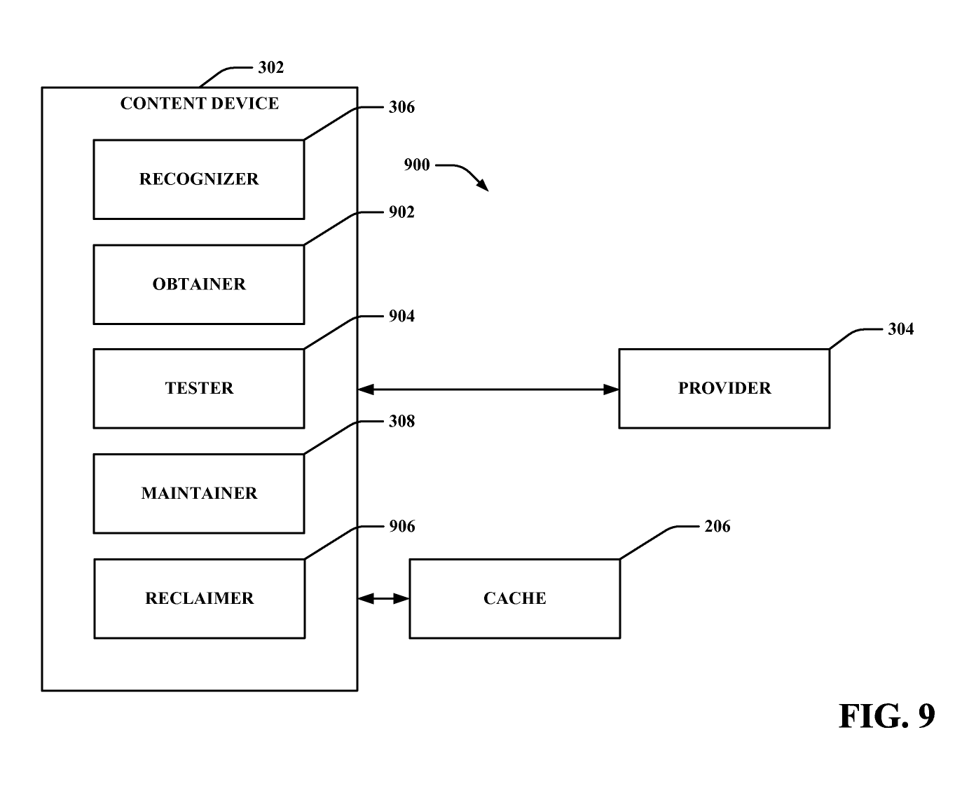

Referring to FIG. 9, an example system 900 is shown for playing content retained in the cache 206 (e.g., supplied for a provider 304). A content device 302 can include a recognizer 306 that identifies multimedia content (e.g., based on identification metadata associated with the content). An obtainer 902 can be used that collects a user instruction to retain the multimedia content (e.g., through the user interface 214 of FIG. 2)—multimedia content associated with the user instruction is retained. A tester 904 can measure availability of cache portions to determine where to place the content. A maintainer 304 can retain at least a portion of the identified multimedia content automatically in a cache. Retention can occur upon a cache portion with a highest availability overall, highest availability in a related portion, and the like. A signal can be collect to play content and a reclaimer 906 can retrieve (e.g., remove from the cache, play from the cache, make a copy, etc.) at least a portion of the retained multimedia content.

According to one embodiment, retrieval and/or deletion is governed by a scoring system. Different pieces of content can be assigned points based upon different characteristics and based upon a score, pieces can be retrieved, deleted, compressed, etc. The scoring system can be governed by a rules set that can be hard coded, modifiable by a central server, modifiable by a user, etc. For example, songs with a moderate audio quality can receive a penalty—the same can take place for songs that expired and songs previously played. The penalties can be aggregated together and retained (as well as updated when appropriate).

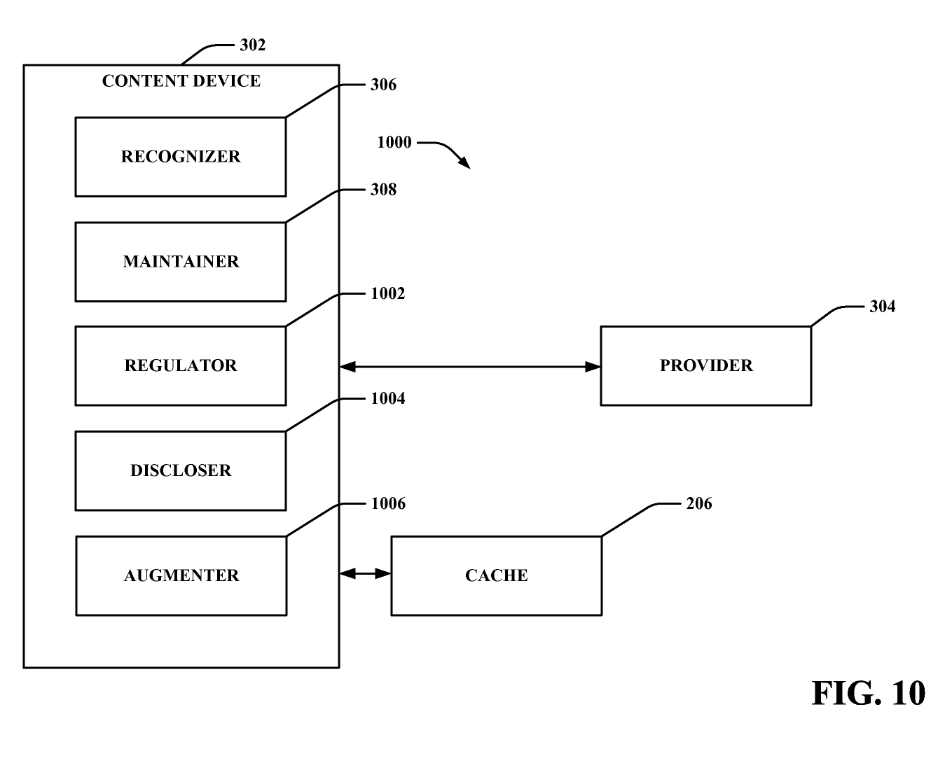

Referring to FIG. 10, an example system 1000 is disclosed for managing content supplied by a provider 304. The provider 304 can be a real-time source of content, such as a radio station, and supply content to a content device 302. A recognizer 306 can identify content that can be placed in a cache 206. With a proper identification, a maintainer 308 can retain the content.

A regulator 1002 can be used that determines if usage of real-time multimedia content if suitable. Playing from the real-time source can occur upon determining that the usage is suitable. However, if it is not suitable (e.g., quality is too low, multiple stations are retrieved upon a single frequency, etc.), then content from the cache 206 can be played. In this scenario, a discloser 1002 plays at least a portion of the retained multimedia content. Targeted advertisements can be disclosed while playing content from the cache 206. The advertisements can be based upon a section of a cache used (e.g., advertisement for a rock concert if the user is listening to rock, such as for a band of a song that finishes playing), a user location, etc. An augmenter 1006 can play the retained content with a tailored advertisement and the advertisement can tailored to the played content.

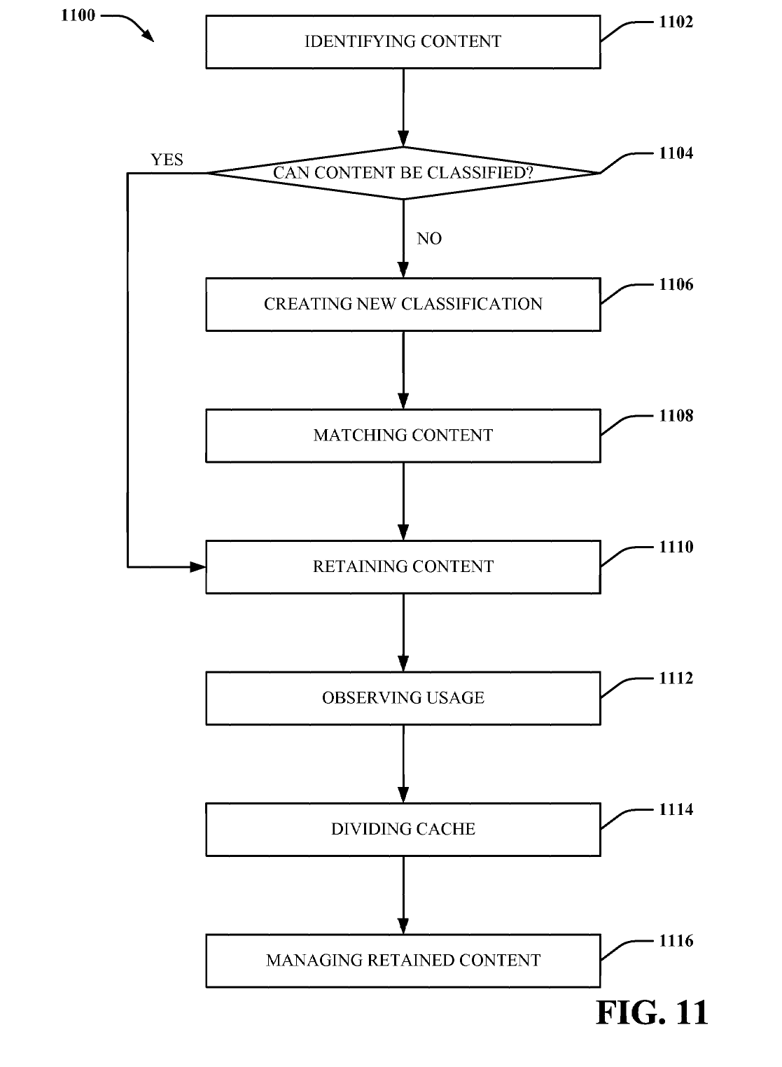

Referring to FIG. 11, an example methodology 1100 is disclosed for retaining multimedia content, commonly upon a cache of a personal electronic device. Content for retention can be identified at event 1102. Once identified, a check 1104 can be performed on if the content can be classified (e.g., does the content have a classification of a certain type such as music type, can the content be appreciated, etc.). If the classification can be classified or should be classified, then classification can occur through action 1106. Based upon the classification, a match can occur to an appropriate storage location through event 1108. According to one embodiment, a singular cache can be used and thus there can no classification check since items that are to be retained are stored in one location or the check 1104 determines classification should not occur.

Regardless of the result of the check 1006, there can be retaining of the identified content at action 1110, commonly in the cache. Usage of the content can be observed through act 1112—observation can include determining how often content is viewed, how often content is played upon a radio station perceived by a content device, and the like. Through this usage, it can be determined that the cache should be segmented. Analysis of the cache and contents can occur and based upon a result of the analysis the cache can be segmented at action 1114. With the cache divided (e.g., into a movies section and other section), management of the cache can occur (e.g., placing movies in the movie section and other into the other section).

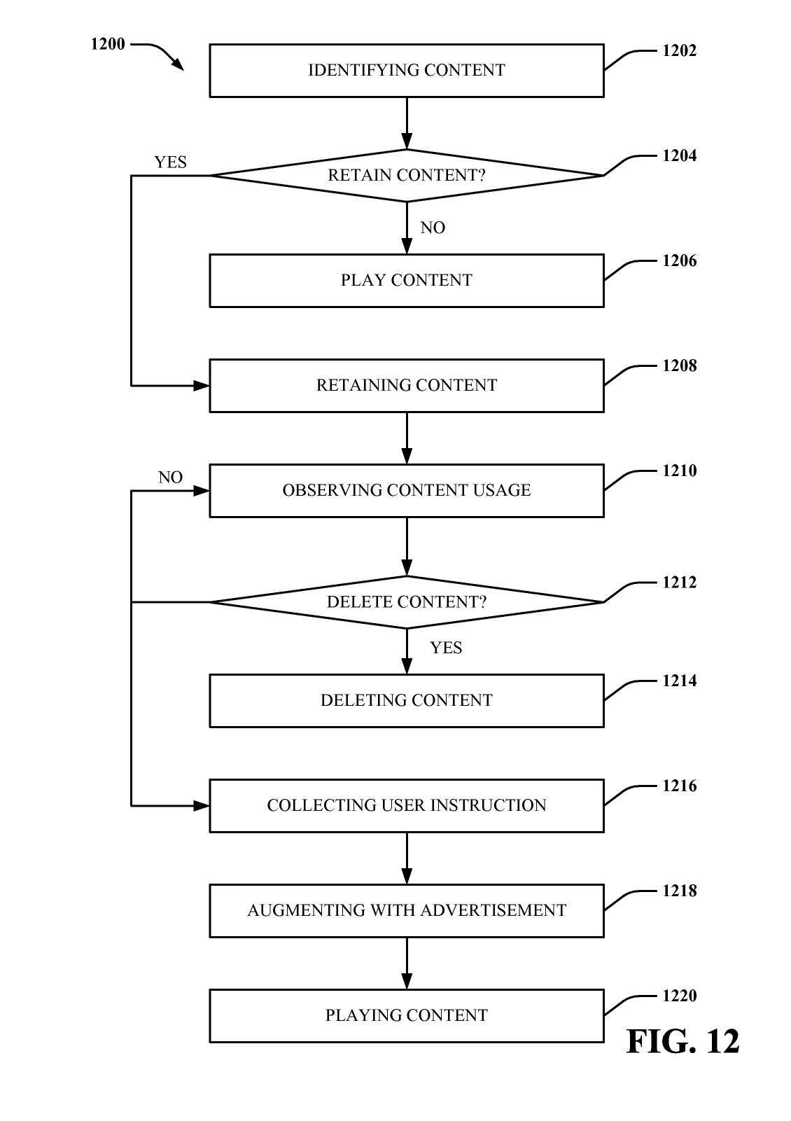

Referring to FIG. 12, an example methodology 1200 is disclosed for having storage of content (e.g., a cache) integrate with a real-time content source. Content that enters a content device can be identified as such in action 1202. A check 1204 can be performed to determine if the content should be retained. If it is determined there should be no retention (e.g., no retention at that time, no retention ever), then the content can be played at act 1206. It is to be appreciated that content can be played while retained as well.

If it is determined that the content should be saved, then retention can occur at action 1208. An observation of content usage can take place at event 1210 and based upon the observation a check 1212 can determine if the content should be deleted. Deletion can occur based upon how long content is retained, usage restrictions, available space, quality of content, number of times played, and the like. If the check 1212 determines that the content should not be deleted, then observation can continue to occur and the check 1212 can continue to run until deletion is appropriate. It is to be appreciated that other instances (e.g., playing content) can occur while the observation and check occur. If it is determined that content should be deleted, the removal of the content can occur at act 1214

At event 1216, a user instruction can be collected to play the content (e.g., upon determining the content should not be deleted). Analysis of the user and/or the content can occur and the content can be augmented with a specific advertisement at act 1218, the advertisement is selected based upon a result of the analysis. The content can be disclosed at event 1220 (e.g., with a general advertisement, with a tailored advertisement, without an advertisement, etc.).

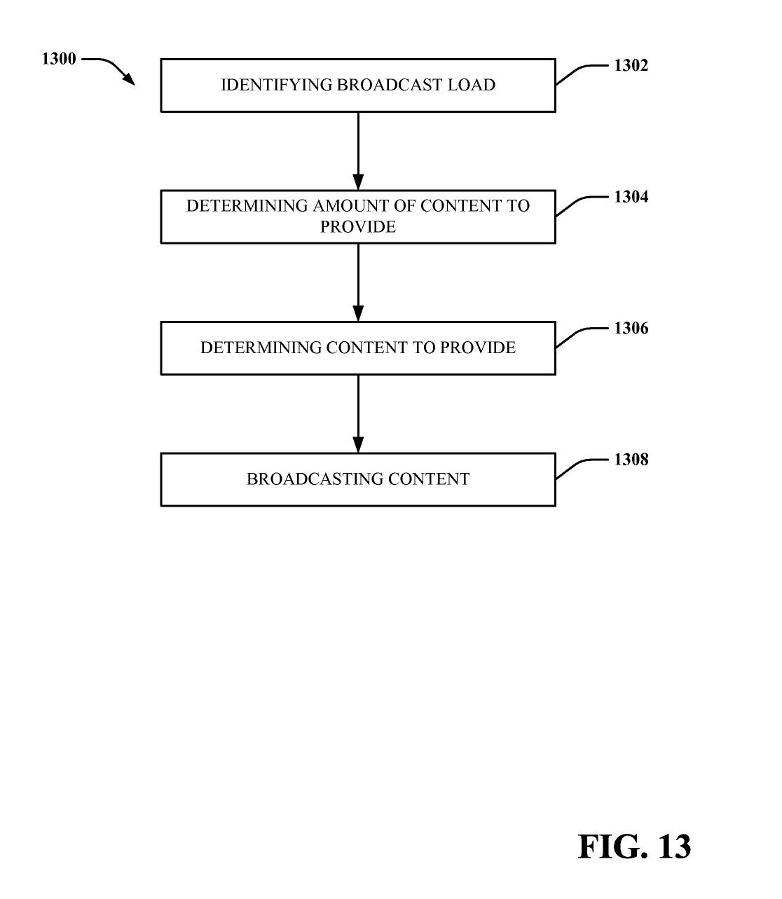

Referring to FIG. 13, an example methodology 1300 is disclosed for operation of a multimedia content provider. At action 1302, there can be analyzing communication channels and identifying a broadcast load based upon a result of the analysis. Through event 1304 there can be determining an amount of multimedia content to provide based upon the identified load. Determining content to provide can take place at act 1306—the determination can be based upon a user request, a station instruction, designation from a third-party, etc. With action 1308, disclosure of the content can occur; verification can take place to determine if the content arrives and if the content does not arrive, then disclosure can be repeated. Additionally, there can be monitoring the content once delivered to determine if there is a usage violation. If a violation occurs, then a notice can be sent, the content can be removed, further disclosure to a device or user can be halted, etc.

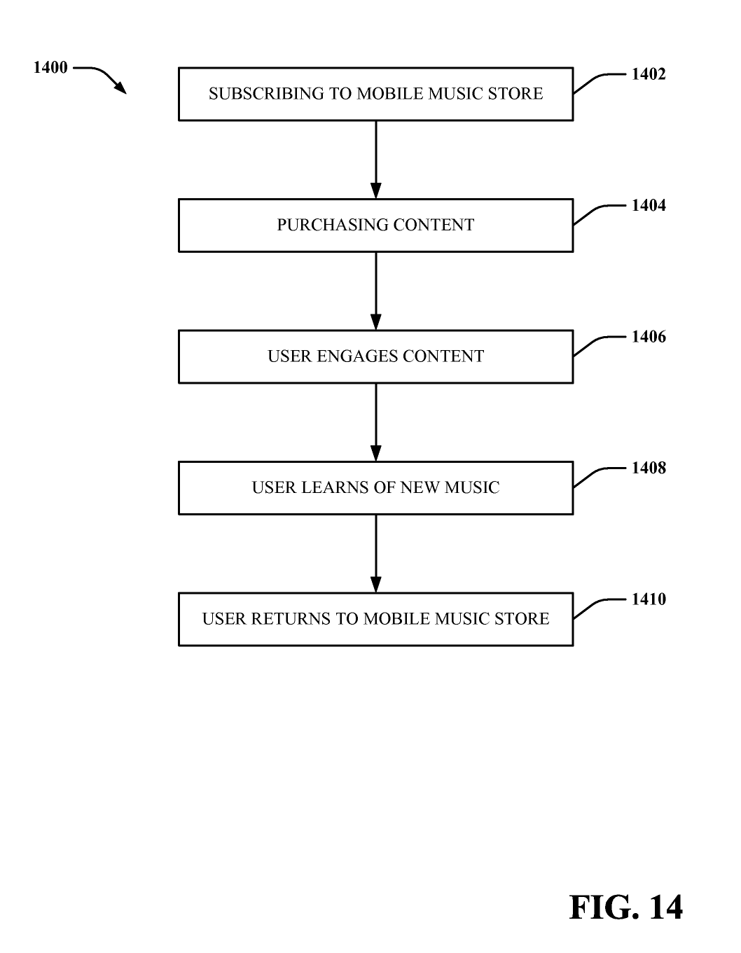

Referring to FIG. 14, an example methodology 1400 is disclosed for obtaining content from a music store. At event 1402, a user can subscribe to a music store in order to obtain content. Content can be designated by the user, suggested by the store, inferred from holdings in a personal cache, etc. and be purchased at action 1404. At event 1406, a user can engage content and the music store can evaluate the usage. Based upon a result of the evaluation, new music can be automatically provided to the user (e.g., for a fee, free of charge, for completion of a survey, etc.). The user can learn of new music at action 1408 (e.g., through a tailored advertisement, listening to a radio station, . . . ) and new music can be purchased and downloaded through act 1410—thus, the music can be identified and retained.

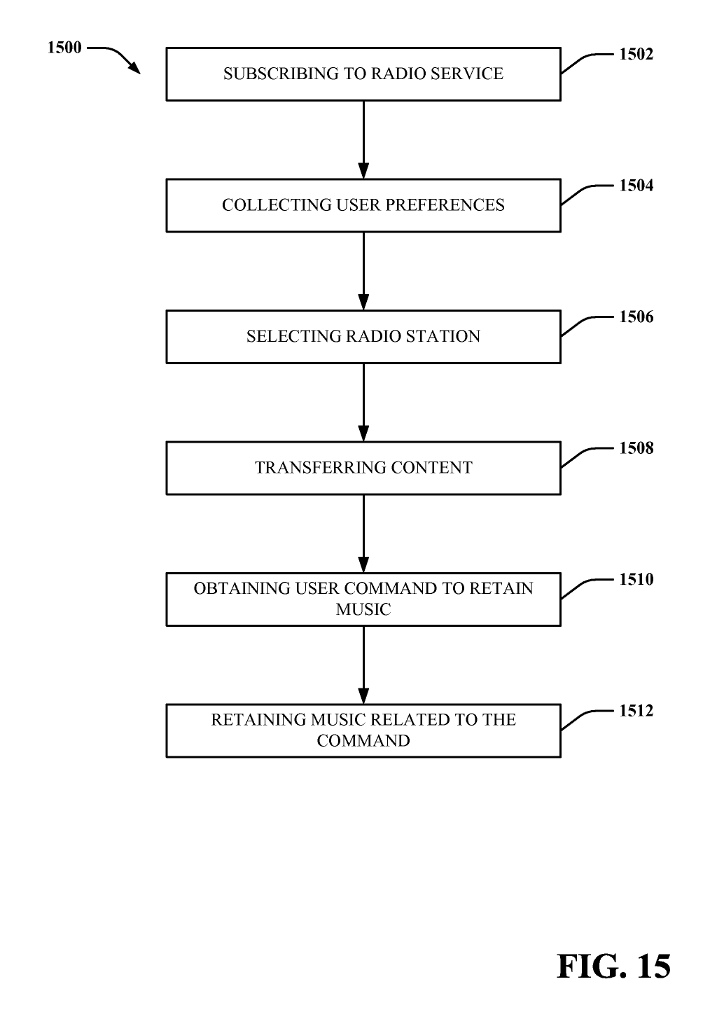

Referring to FIG. 15, an example methodology 1500 is disclosed for obtaining content from a real-time source, such as a radio station. A user can subscribe to a radio service (e.g., satellite radio) through event 1502. A set of user preferences can be collected through event 1504 and based upon the preferences, a music channel can be selected at act 1506 (e.g., automatically implemented, suggested, etc.). It is to be appreciated that the user can override the preference selection and select a radio station. As part of the subscription service, a user can download music played upon a radio station. Content can be transferred at event 1508 and a user can designate a song to download at action 1510. According to an alternative embodiment, the content can be automatically selected for downloading. The music can be identified and retained at act 1512.

Referring to FIGS. 11-15, methodologies relating to a usage of multimedia content. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

It will be appreciated that, in accordance with one or more aspects described herein, inferences can be made regarding whether a there should be deletion of content of a cache, if content should be retained, etc. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. It will be appreciated that the foregoing examples are illustrative in nature and are not intended to limit the number of inferences that can be made or the manner in which such inferences are made in conjunction with the various embodiments and/or methods described herein.

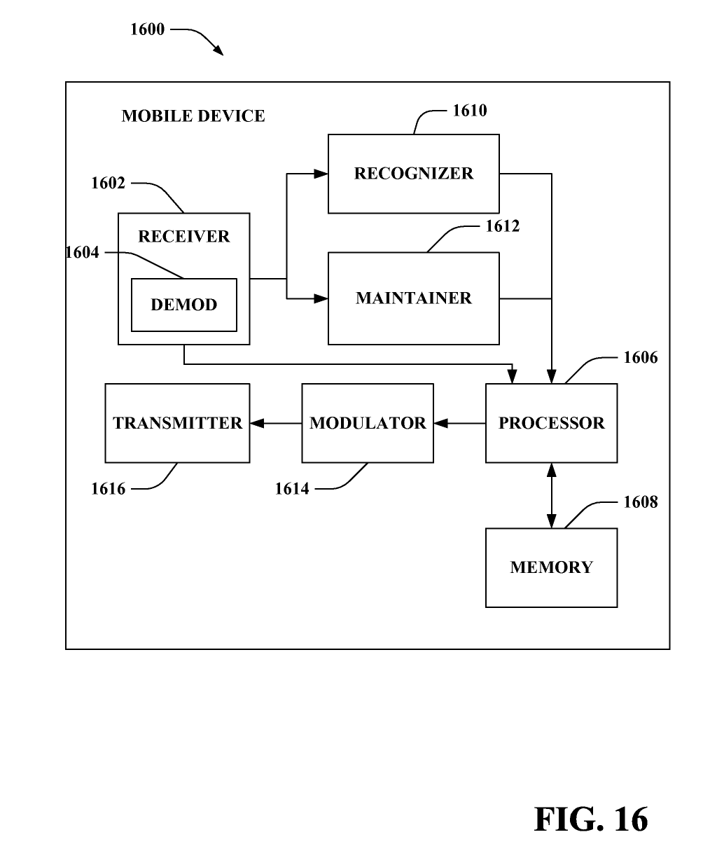

FIG. 16 is an illustration of a mobile device 1600 (e.g., the mobile device 1600 can be an example content device 302) that facilitates management of information upon a cache. Mobile device 1600 comprises a receiver 1602 that receives a signal from, for instance, a receive antenna (not shown), and performs typical actions thereon (e.g., filters, amplifies, downconverts, etc.) the received signal and digitizes the conditioned signal to obtain samples. Receiver 1602 can be, for example, an MMSE receiver, and can comprise a demodulator 1604 that can demodulate received symbols and provide them to a processor 1606 for channel estimation. Processor 1606 can be a processor dedicated to analyzing information received by receiver 1602 and/or generating information for transmission by a transmitter 1616, a processor that controls one or more components of mobile device 1600, and/or a processor that both analyzes information received by receiver 1602, generates information for transmission by transmitter 1616, and controls one or more components of mobile device 1600.

Mobile device 1600 can additionally comprise memory 1608 that is operatively coupled to processor 1606 and that can store data to be transmitted, received data, information related to available channels, data associated with analyzed signal and/or interference strength, information related to an assigned channel, power, rate, or the like, and any other suitable information for estimating a channel and communicating via the channel. Memory 1608 can additionally store protocols and/or algorithms associated with estimating and/or utilizing a channel (e.g., performance based, capacity based, etc.).

It will be appreciated that the data store (e.g., memory 1608) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1608 of the subject systems and methods is intended to comprise, without being limited to, these and any other suitable types of memory.

Processor 1602 is further operatively coupled to a recognizer 1610 that identifies multimedia content and a maintainer 1612 that retains at least a portion of the identified multimedia content automatically in a cache. Mobile device 1600 still further comprises a modulator 1614 and a transmitter 1616 that transmits a signal (e.g., base CQI and differential CQI) to, for instance, a base station, another mobile device, etc. Although depicted as being separate from the processor 1606, it is to be appreciated that the recognizer 1610 and/or maintainer 1612 can be part of processor 1606 or a number of processors (not shown).

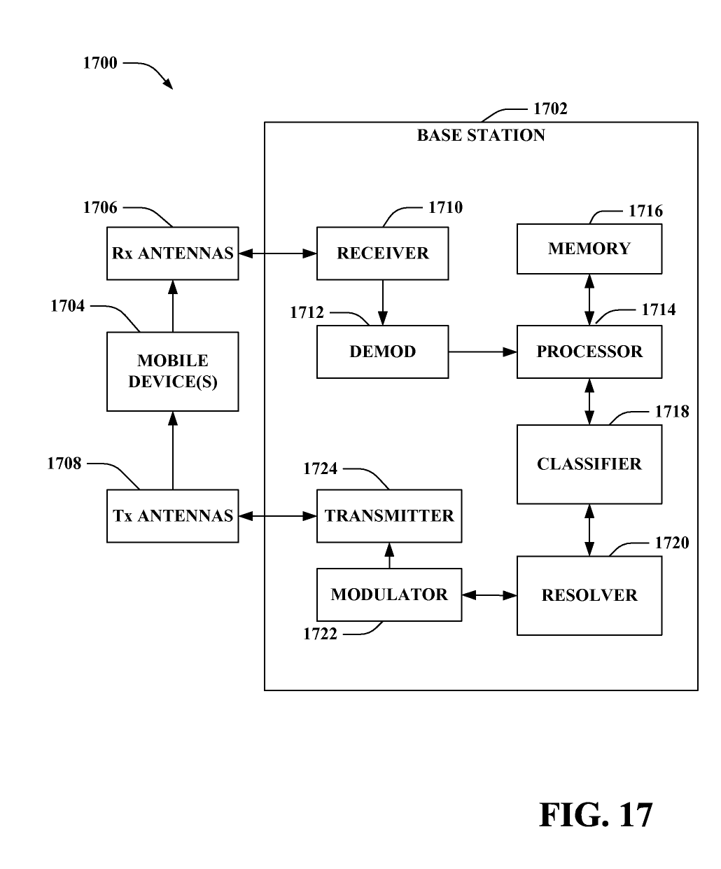

FIG. 17 is an illustration of a system 1700 that facilitates management of multimedia content. System 1700 comprises a base station 1702 (e.g. access point, provider 304 of FIG. 3, . . . ) with a receiver 1710 that receives signal(s) from one or more mobile devices 1704 through a plurality of receive antennas 1706, and a transmitter 1724 that transmits to the one or more mobile devices 1704 through a plurality of transmit antennas 1708. Receiver 1710 can receive information from receive antennas 1706 and is operatively associated with a demodulator 1712 that demodulates received information. Demodulated symbols are analyzed by a processor 1714 that can be similar to the processor described above with regard to FIG. 16, and which is coupled to a memory 1716 that stores information related to estimating a signal (e.g., pilot) strength and/or interference strength, data to be transmitted to or received from mobile device(s) 1704 (or a disparate base station (not shown)), and/or any other suitable information related to performing the various actions and functions set forth herein.

Processor 1714 is further coupled to a classifier 1718 that identifies a broadcast load as well as a resolver 1720 that determines an amount of multimedia content to provide based upon the identified load. Information to be transmitted can be provided to a modulator 1722. Modulator 1722 can multiplex the information for transmission by a transmitter 1724 through antenna 1708 to mobile device(s) 1704. Although depicted as being separate from the processor 1714, it is to be appreciated that the classifier 1718 and/or resolver 1720 can be part of processor 1714 or a number of processors (not shown).

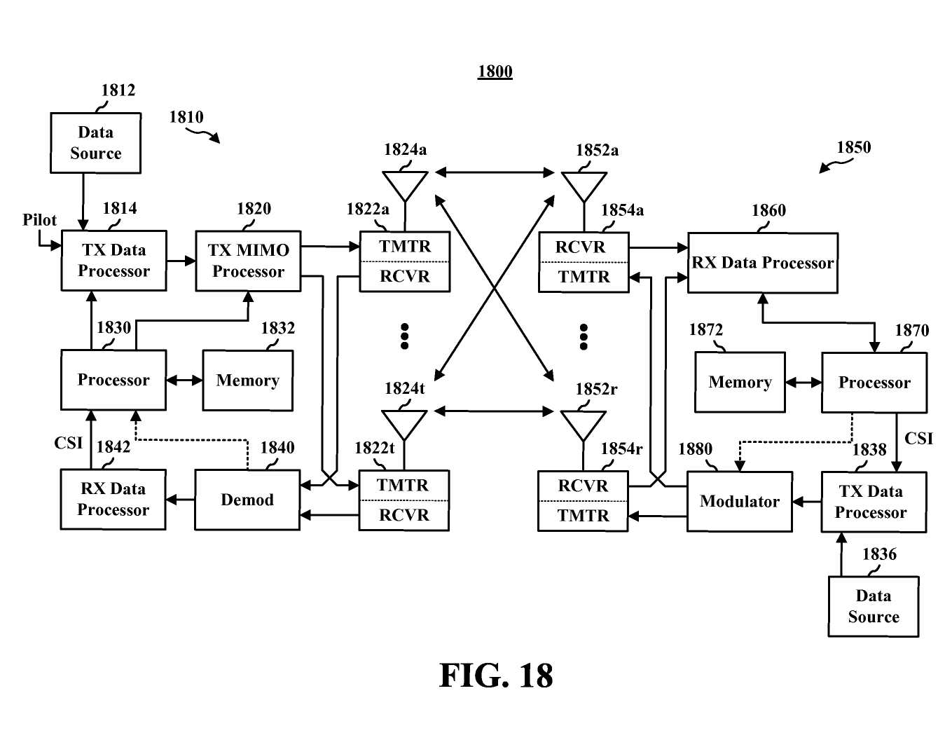

FIG. 18 shows an example wireless communication system 1800. The wireless communication system 1800 depicts one base station 1810 and one mobile device 1850 for sake of brevity. However, it is to be appreciated that system 1800 can include more than one base station and/or more than one mobile device, wherein additional base stations and/or mobile devices can be substantially similar or different from example base station 1810 and mobile device 1850 described below. In addition, it is to be appreciated that base station 1810 and/or mobile device 1850 can employ the systems (FIGS. 1-10 and 16-17) and/or methods (FIGS. 11-15) described herein to facilitate wireless communication there between.

At base station 1810, traffic data for a number of data streams is provided from a data source 1812 to a transmit (TX) data processor 1814. According to an example, each data stream can be transmitted over a respective antenna. TX data processor 1814 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1850 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1830.

The modulation symbols for the data streams can be provided to a TX MIMO processor 1820, which can further process the modulation symbols (e.g., for OFDM). TX MIMO processor 1820 then provides N_{T} modulation symbol streams to N_{T} transmitters (TMTR) 1822a through 1822t. In various embodiments, TX MIMO processor 1820 applies beamforming weights to the symbols of the data streams and to the antenna from which the symbol is being transmitted.

Each transmitter 1822 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1822a through 1822t are transmitted from N_{T} antennas 1824a through 1824t, respectively.

At mobile device 1850, the transmitted modulated signals are received by N_{R} antennas 1852a through 1852r and the received signal from each antenna 1852 is provided to a respective receiver (RCVR) 1854a through 1854r. Each receiver 1854 conditions (e.g., filters, amplifies, and downconverts) a respective signal, digitizes the conditioned signal to provide samples, and further processes the samples to provide a corresponding “received” symbol stream.

An RX data processor 1860 can receive and process the N_{R} received symbol streams from N_{R} receivers 1854 based on a particular receiver processing technique to provide N_{T} “detected” symbol streams. RX data processor 1860 can demodulate, deinterleave, and decode each detected symbol stream to recover the traffic data for the data stream. The processing by RX data processor 1860 is complementary to that performed by TX MIMO processor 1820 and TX data processor 1814 at base station 1810.

A processor 1870 can periodically determine which preceding matrix to utilize as discussed above. Further, processor 1870 can formulate a reverse link message comprising a matrix index portion and a rank value portion.

The reverse link message can comprise various types of information regarding the communication link and/or the received data stream. The reverse link message can be processed by a TX data processor 1838, which also receives traffic data for a number of data streams from a data source 1836, modulated by a modulator 1880, conditioned by transmitters 1854a through 1854r, and transmitted back to base station 1810.

At base station 1810, the modulated signals from mobile device 1850 are received by antennas 1824, conditioned by receivers 1822, demodulated by a demodulator 1840, and processed by a RX data processor 1842 to extract the reverse link message transmitted by mobile device 1850. Further, processor 1830 can process the extracted message to determine which preceding matrix to use for determining the beamforming weights.

Processors 1830 and 1870 can direct (e.g., control, coordinate, manage, etc.) operation at base station 1810 and mobile device 1850, respectively. Respective processors 1830 and 1870 can be associated with memory 1832 and 1872 that store program codes and data. Processors 1830 and 1870 can also perform computations to derive frequency and impulse response estimates for the uplink and downlink, respectively.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

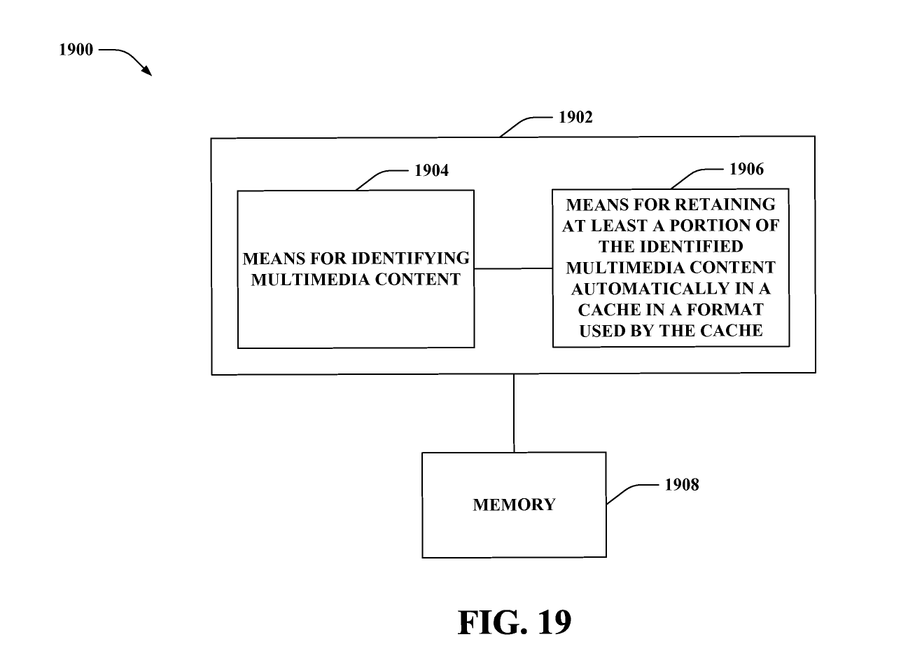

With reference to FIG. 19, illustrated is a system 1900 that effectuates placement of multimedia content upon a cache. For example, system 1900 can reside at least partially within a mobile device. It is to be appreciated that system 1900 is represented as including functional blocks, which can be functional blocks that represent functions implemented by a processor, software, or combination thereof (e.g., firmware). System 1900 includes a logical grouping 1902 of means that can act in conjunction. For instance, logical grouping 1902 can include means for identifying multimedia content 1904. Additionally, the logical grouping 1902 can incorporate means for retaining at least a portion of the identified multimedia content automatically in a cache 1906. Additionally, system 1900 can include a memory 1908 that retains instructions for executing functions associated with means 1904 and 1906. While shown as being external to memory 1908, it is to be understood that one or more of means 1904 and 1906 can exist within memory 1908.

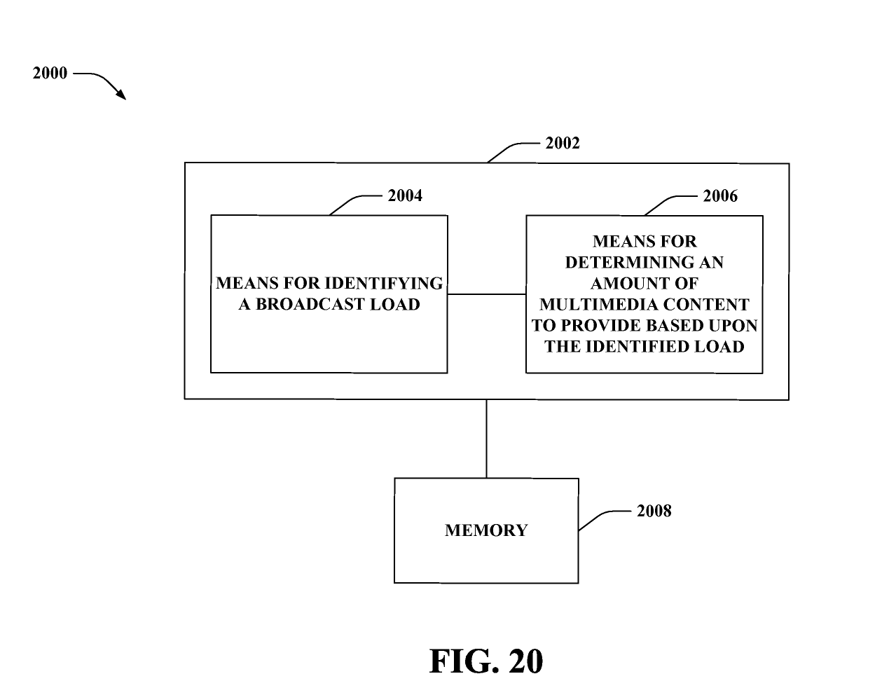

Turning to FIG. 20, illustrated is a system 2000 that produces multimedia content (e.g., as a store, as a radio station, etc.). System 2000 can reside within a base station or transmitter, for instance. As depicted, system 2000 includes functional blocks that can represent functions implemented by a processor, software, or combination thereof (e.g. firmware). System 2000 includes a logical grouping 2002 of means that facilitate controlling forward link transmission. Logical grouping 2002 means for identifying a broadcast load 2004 and means for determining an amount of multimedia content to provide based upon the identified load 2006. Additionally, system 2000 can include a memory 2008 that retains instructions for executing functions associated with means 2004 and 2006. While shown as being external to memory 2010, it is to be understood that means 2004 and 2006 can exist within memory 2010.

The various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Additionally, at least one processor can comprise one or more modules operable to perform one or more of the steps and/or actions described above.

Further, the steps and/or actions of a method or algorithm described in connection with the aspects disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some aspects, the processor and the storage medium can reside in an ASIC. Additionally, the ASIC can reside in a user terminal. In the alternative, the processor and the storage medium can reside as discrete components in a user terminal. Additionally, in some aspects, the steps and/or actions of a method or algorithm can reside as one or any combination or set of codes and/or instructions on a machine readable medium and/or computer readable medium, which can be incorporated into a computer program product.

In one or more aspects, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments can be described or claimed in the singular, the plural is contemplated unless limitation to the singular is explicitly stated. Additionally, all or a portion of any aspect and/or embodiment can be utilized with all or a portion of any other aspect and/or embodiment, unless stated otherwise.

What is claimed is:

1. A method for managing cache storage operable upon a wireless communication device, comprising:
identifying multimedia content; and
retaining at least a portion of the identified multimedia content automatically in a cache in a format used by the cache.

2. The method of claim 1, wherein the multimedia content is music content.

3. The method of claim 1, further comprising:
classifying the identified multimedia content; and
matching the multimedia content with a classified cache that corresponds to the classification of the multimedia content, wherein retention occurs automatically upon the matched classified cache.

4. The method of claim 3, further comprising:
observing usage related to multimedia content; and
dividing a cache into at least two classifications based upon the observation.

5. The method of claim 1, further comprising monitoring usage of retained multimedia content.

6. The method of claim 5, further comprising determining if the retained content should be deleted based at least upon a result of the monitoring.

7. The method of claim 1, further comprising determining an amount of retention time for retained multimedia content.

8. The method of claim 7, further comprising determining if the retained content should be deleted based at least upon the determined retention time such that content with a longest retention time is deleted.

9. The method of claim 1, further comprising determining a quality level of the multimedia content.

10. The method of claim 9, further comprising determining if the multimedia content is of a sufficient quality level prior to retention, wherein automatic retention occurs upon determining that the identified multimedia content is of the suitable quality level.

11. The method of claim 9, further comprising determining if the retained content should be deleted based at least upon the determined quality level of the retained multimedia content such that multimedia content of a lowest quality level is deleted.

12. The method of claim 1, further comprising determining if retained multimedia content is expired.

13. The method of claim 12, further comprising deleting the retained multimedia content if it is determined that the content is expired.

14. The method of claim 1, further comprising measuring availability of cache portions, wherein retention occurs upon a cache portion with a highest availability.

15. The method of claim 1, further comprising retrieving at least a portion of the retained multimedia content.

16. The method of claim 15, wherein retrieval is governed by a scoring system.

17. The method of claim 1, further comprising playing at least a portion of the retained multimedia content.

18. The method of claim 17, further comprising determining if usage of real-time multimedia content if suitable, wherein the playing occurs upon determining that the usage is suitable.

19. The method of claim 17, further comprising playing the retained content with a tailored advertisement, the advertisement is tailored to the played content.

20. The method of claim 1, wherein the identified multimedia content is supplied from a real-time source.

21. The method of claim 1, further comprising collecting a user instruction to retain the multimedia content, wherein multimedia content associated with the user instruction is retained.

22. An apparatus, comprising:
a recognizer that identifies multimedia content; and
a maintainer that retains at least a portion of the identified multimedia content automatically in a cache.

23. The apparatus of claim 22, wherein the multimedia content is music content.

24. The apparatus of claim 22, further comprising:
an organizer that classifies the identified multimedia content; and
a grouper that matches the multimedia content with a classified cache that corresponds to the classification of the multimedia content, retention of the maintainer occurs automatically upon the matched classified cache.

25. The apparatus of claim 24, further comprising:
an examiner that observes usage related to multimedia content; and
a separator that divides a cache into at least two classifications based upon the observation.

26. The apparatus of claim 22, further comprising an observer that monitors usage of retained multimedia content.

27. The apparatus of claim 26, further comprising a manager that determines if the retained content should be deleted based at least upon a result of the monitoring.

28. The apparatus of claim 22, further comprising a timer that determines an amount of retention time for retained multimedia content.

29. The apparatus of claim 28, further comprising a measurer that determines if the retained content should be deleted based at least upon the determined retention time such that content with a longest retention time is deleted.

30. The apparatus of claim 22, further comprising an analyzer that determines a quality level of the multimedia content.

31. The apparatus of claim 30, further comprising a selector that determines if the multimedia content is of a sufficient quality level prior to retention, wherein automatic retention by the maintainer occurs upon determining that the identified multimedia content is of the suitable quality level.

32. The apparatus of claim 30, further comprising an evaluator that determines if the retained content should be deleted based at least upon the determined quality level of the retained multimedia content such that multimedia content of a lowest quality level is deleted.

33. The apparatus of claim 22, further comprising a verifier that determines if retained multimedia content is expired.

34. The apparatus of claim 33, further comprising a confirmer that deletes the retained multimedia content if it is determined that the content is expired.

35. The apparatus of claim 22, further comprising a tester that measures availability of cache portions, wherein retention occurs upon a cache portion with a highest availability.

36. The apparatus of claim 22, further comprising a reclaimer that retrieves at least a portion of the retained multimedia content.

37. The apparatus of claim 36, wherein retrieval is governed by a scoring system.

38. The apparatus of claim 22, further comprising a discloser that plays at least a portion of the retained multimedia content.

39. The apparatus of claim 38, further comprising a regulator that determines if usage of real-time multimedia content if suitable, wherein the playing occurs upon determining that the usage is suitable.

40. The apparatus of claim 38, further comprising an augmenter that plays the retained content with a tailored advertisement, the advertisement is tailored to the played content.

41. The apparatus of claim 22, wherein the identified multimedia content is supplied from a real-time source.

42. The apparatus of claim 22, further comprising an obtainer that collects a user instruction to retain the multimedia content, wherein multimedia content associated with the user instruction is retained.

43. At least one processor configured to manage cache storage, comprising:
a first module for identifying multimedia content; and
a second module for retaining at least a portion of the identified multimedia content automatically in a cache.

44. A computer program product, comprising:
a computer-readable medium comprising:
a first set of codes for causing a computer to identify multimedia content; and
a second set of codes for causing the computer to retain at least a portion of the identified multimedia content automatically in a cache.

45. An apparatus, comprising:
means for identifying multimedia content; and
means for retaining at least a portion of the identified multimedia content automatically in a cache.

46. A method for providing multimedia content operable upon a wireless communication device, comprising:
identifying a broadcast load; and
determining an amount of multimedia content to provide based upon the identified load.

47. At least one processor configured to provide multimedia content, comprising:
a first module for identifying a broadcast load; and
a second module for determining an amount of multimedia content to provide based upon the identified load.

48. A computer program product, comprising:
a computer-readable medium comprising:
a first set of codes for causing a computer to identifying a broadcast load; and
a second set of codes for causing the computer to determine an amount of multimedia content to provide based upon the identified load.

49. An apparatus, comprising:
means for identifying a broadcast load; and
means for determining an amount of multimedia content to provide based upon the identified load.

50. An apparatus, comprising:
a classifier that identifies a broadcast load; and
a resolver that determines an amount of multimedia content to provide based upon the identified load.
